(19) United States
(12) Patent Application Publication
(10) Pub. No.: US 2013/0009924 A1
(43) Pub. Date: Jan. 10, 2013

(54) DISPLAY DEVICE AND METHOD OF DRIVING THE SAME

(75) Inventor: Masahiro Imai, Osaka-shi (JP)

(73) Assignee: SHARP KABUSHIKI KAISHA, Osaka-shi, Osaka (JP)

(21) Appl. No.: 13/635,961

(22) PCT Filed: Mar. 18, 2011
(86) PCT No.: PCT/JP2011/056557

§ 371 Date: Sep. 19, 2012

(30) Foreign Application Priority Data
Apr. 2, 2010 (JP) 2010-085622

(51) Int. Cl. G06F 3/038

(52) U.S. Cl. 345/204

(57) ABSTRACT

In a display device, a capacitance forming electrode is provided such that an additional capacitance is formed between the pixel electrode in pixel formation portion and the capacitance forming electrode, and the capacitance value of the additional capacitance is set equal to the capacitance value of the gate-drain capacitance. After the scanning signal being applied to the scanning signal electrode fall, a capacitance forming electrode driver raises the capacitance forming electrode drive signal being applied to the capacitance forming electrode that corresponds to the scanning signal electrodes.

### TECHNICAL FIELD

The present invention relates to an active-matrix display device using switching elements such as thin-film transistors and a method for driving the same.

### BACKGROUND ART

Conventionally, active-matrix liquid crystal display devices including TFTs (thin-film transistors) as switching elements are known. Such a liquid crystal display device is equipped with a liquid crystal panel and a circuit for driving the panel as main components, the liquid crystal panel being a display portion composed of a plurality of pixel formation portions arranged in a matrix. The liquid crystal panel has a plurality of source bus electrodes (video signal lines) and a plurality of gate bus electrodes (scanning signal lines) formed in a grid so as to cross one another, and the liquid crystal panel also has auxiliary capacitance electrodes formed in one-to-one correspondence with the gate bus electrodes. One pixel formation portion corresponds to each intersection of the plurality of source bus electrodes and the plurality of gate bus electrodes. Moreover, the liquid crystal panel includes a common electrode, which is provided commonly for the plurality of pixel formation portions arranged in a matrix and is opposed to pixel electrodes included in the pixel formation portions with respect to the liquid crystal.

FIG. 13 is a circuit diagram illustrating the configuration of the pixel formation portion in the conventional liquid crystal display device described above. Each pixel formation portion includes a TFT (referred to below as a “pixel TFT”) 10, which is connected at a gate electrode to a gate bus electrode GL passing through its corresponding intersection and at a source electrode to a source bus electrode SL passing through the intersection, a pixel electrode 11 connected to a drain electrode of the pixel TFT 10, a common electrode (opposing electrode) 18 and an auxiliary capacitance electrode 19 which are commonly provided for the plurality of pixel formation portions, a pixel capacitance (liquid crystal capacitance) Clc formed by the pixel electrode 11 and the common electrode 18, an auxiliary capacitance Ccs formed by the pixel electrode 11 and the auxiliary capacitance electrode 19, a capacitance (referred to below as a “source-drain capacitance”) Csd formed by the source bus electrode SL and the drain electrode of the pixel TFT 10 (the pixel electrode 11), and a capacitance (referred to below as a “gate-drain capacitance”) Cgd formed by the gate bus electrode GL and the drain electrode of the pixel TFT 10 (the pixel electrode 11), as shown in FIG. 13. Note that in the following, the capacitance values of the capacitances Clc, Ccs, Csd, and Cgd will also be denoted by the same characters “Clc”, “Ccs”, “Csd”, and “Cgd”.

As described above, each pixel formation portion has the gate-drain capacitance Cgd formed therein. Accordingly, in the case where a video signal S with a waveform as shown in FIG. 14A is being applied to the source bus electrode SL, when the voltage of a scanning signal G falls from gate-on voltage Vgh to gate-off voltage Vgl, as shown in FIG. 14B, the pixel electrode experiences voltage variation ΔVd in potential (pixel potential) Vd due to the gate-drain capacitance Cgd, as shown in FIG. 14C. This voltage variation ΔVd is represented by equation (1) below.

ΔVd=(Vgh−Vgl)×Cgd/(Clc+Ccs+Csd+Cgd) (1)

Note that the voltage variation ΔVd is called “feedthrough voltage”, “pull-in voltage”, or the like.

Incidentally, when a positive voltage (with respect to potential Vcom of the common electrode 18) is applied to the pixel electrode 11, the above-described voltage variation ΔVd functions to cause a voltage applied to the liquid crystal to be lower than a desired level, as can be appreciated from the portion denoted by character 91 in FIG. 14C. On the other hand, when a negative voltage is applied to the pixel electrode 11, the above-described voltage variation ΔVd functions to cause the voltage applied to the liquid crystal to be higher than a desired level, as can be appreciated from the portion denoted by character 92 in FIG. 14C. In this manner, the voltage applied to the liquid crystal varies between the case where a positive voltage is applied to the pixel electrode 11 and the case where a negative voltage is applied to the pixel electrode 11. As a result, flicker (flashing) occurs on the screen.

Japanese Laid-Open Patent Publication Nos. 4-5633 and 4-14091 therefore disclose inventions in which each single pixel formation portion includes an N-channel TFT and a P-channel TFT thereby to prevent occurrence of flicker due to feedthrough voltage (pull-in voltage). In the display device disclosed in Japanese Laid-Open Patent Publication No. 4-5633, the N-channel TFT and the P-channel TFT in each pixel formation portion are alternately brought into ON state, thereby causing voltage variation ΔVd to move to the potential of the common electrode regardless of the polarity of the voltage applied to the liquid crystal. In the display device disclosed in Japanese Laid-Open Patent Publication No. 4-14091, the N-channel TFT and the P-channel TFT are simultaneously brought into ON state, so that a video signal is written via both the N-channel TFT and the P-channel TFT, thereby setting voltage variation ΔVd to 0.

### PRIOR ART DOCUMENT(S)

### Patent Document(s)

Patent Document 1: Japanese Laid-Open Patent Publication No. 4-5633

Patent Document 2: Japanese Laid-Open Patent Publication No. 4-14091

### SUMMARY OF THE INVENTION

### Problems to be Solved by the Invention

However, the inventions disclosed in Japanese Laid-Open Patent Publication Nos. 4-5633 and 4-14091 require the N-channel TFT and the P-channel TFT to be provided in each pixel formation portion. As a result, the configuration of a pixel circuit is complicated, resulting in increased cost.

Therefore, an objective of the present invention is to provide a display device capable of preventing occurrence of flicker due to feedthrough voltage (pull-in voltage) with a simple configuration.

### Means for Solving the Problems

A first aspect of the present invention is directed to an active-matrix display device having a plurality of video signal electrodes, a plurality of scanning signal electrodes crossing the plurality of video signal electrodes, and a plurality of pixel formation portions arranged in a matrix so as to correspond to their respective intersections of the plurality of video signal electrodes and the plurality of scanning signal electrodes, the device comprising:

a plurality of capacitance forming electrodes crossing the plurality of video signal electrodes;

a video signal electrode drive portion for applying video signals to the plurality of video signal electrodes, the signals representing an image to be displayed;

a scanning signal electrode drive portion for selectively driving the plurality of scanning signal electrodes by applying scanning signals to the plurality of scanning signal electrodes; and

a capacitance forming electrode drive portion for driving the plurality of capacitance forming electrodes, wherein,

each of the plurality of capacitance forming electrodes is provided so as to correspond to at least one of the plurality of scanning signal electrodes,

each of the pixel formation portions includes:
a switching element to be brought into ON state when a scanning signal being applied to a corresponding scanning signal electrode is at a first level and OFF state when the scanning signal is at a second level, the corresponding scanning signal electrode being a scanning signal electrode passing through the intersection that corresponds to the switching element;
a pixel electrode disposed so as to have a first capacitance formed between the corresponding scanning signal electrode and the pixel electrode and connected via the switching element to a video signal electrode passing through the corresponding intersection; and
a second capacitance formed by the capacitance forming electrode corresponding to the corresponding scanning signal electrode and the pixel electrode, and

after the scanning signals being applied to the scanning signal electrodes change from the first level to the second level, the capacitance forming electrode drive portion changes voltages being applied to the capacitance forming electrodes that correspond to the scanning signal electrodes, in an opposite direction to the scanning signals changing from the first level to the second level.

According to a second aspect of the present invention, in the first aspect of the present invention,

the capacitance value of the second capacitance is set equal to the capacitance value of the first capacitance, and

after scanning signals being applied to the scanning signal electrodes change from the first level to the second level, the capacitance forming electrode drive portion changes the voltages being applied to the capacitance forming electrodes that correspond to the scanning signal electrodes, from the second level to the first level.

According to a third aspect of the present invention, in the first aspect of the present invention,

the capacitance value of the second capacitance is set greater than the capacitance value of the first capacitance, and

the capacitance forming electrode drive portion drives the capacitance forming electrodes such that the amplitudes of the voltages being applied to the capacitance forming electrodes are narrower than those of the scanning signals.

According to a fourth aspect of the present invention, in the first aspect of the present invention,

the capacitance value of the second capacitance is set smaller than the capacitance value of the first capacitance, and

the capacitance forming electrode drive portion drives the capacitance forming electrodes such that the amplitudes of the voltages being applied to the capacitance forming electrodes are wider than those of the scanning signals.

According to a fifth aspect of the present invention, in the first aspect of the present invention,

the capacitance value of the second capacitance is set to M times as great as the capacitance value of the first capacitance (where M is a positive number), and

the capacitance forming electrode drive portion drives the capacitance forming electrodes such that the amplitudes of the voltages being applied to the capacitance forming electrodes are set to 1/M of the amplitudes of the scanning signals.

According to a sixth aspect of the present invention, in the first aspect of the present invention,

each of the pixel formation portions consists of a first sub-pixel formation portion and a second sub-pixel formation portion, each including the switching element, the pixel electrode, and the second capacitance.

According to a seventh aspect of the present invention, in the sixth aspect of the present invention,

the display device further comprises a plurality of second video signal electrodes the number of which is equal to the number of the plurality of video signal electrodes, wherein,
the video signal electrode drive portion further applies the video signals to the plurality of second video signal electrodes,
the pixel electrode included in the first sub-pixel formation portion is connected to the video signal electrode via the switching element, and

the pixel electrode included in the second sub-pixel formation portion is connected to the second video signal electrode via the switching element.

According to an eighth aspect of the present invention, in the sixth aspect of the present invention,

the display device further comprises a plurality of second video signal electrodes the number of which is equal to the number of plurality of scanning signal electrodes, wherein,

the scanning signal electrode drive portion further applies the scanning signals to the plurality of second scanning signal electrodes, thereby selectively driving the plurality of scanning signal electrodes and the plurality of second scanning signal electrodes such that the scanning signal electrodes and the second scanning signal electrodes are alternately selected, and

in the second sub-pixel formation portion,
the switching element is brought into ON state when a scanning signal not being applied to the corresponding scanning signal electrode but instead to a corresponding second scanning signal electrode is at a first level and OFF state when the scanning signal is at a second level, the corresponding second scanning signal electrode being a second scanning signal electrode passing through the intersection that corresponds to the switching element,
the pixel electrode is disposed so as to have the first capacitance formed between the corresponding second scanning signal electrode, in place of the corresponding scanning signal electrode, and the pixel electrode, and

after both the scanning signals being applied to the scanning signal electrodes that correspond to the capacitance forming electrodes and the scanning signals being applied to the second scanning signal electrodes that correspond to the capacitance forming electrodes completely change from the first level to the second level, the capacitance forming electrode drive portion changes the voltages being applied to the capacitance forming electrodes, in an opposite direction to both of the scanning signals changing from the first level to the second level.

According to a ninth aspect of the present invention, in the sixth aspect of the present invention,

the pixel electrode included in each of the pixel formation portions is disposed so as to have a third capacitance formed between an electrode other than the corresponding scanning signal electrode and the pixel electrode, and

the third capacitance is different in capacitance value between the first sub-pixel formation portion and the second sub-pixel formation portion.

According to a tenth aspect of the present invention, in the first aspect of the present invention,

the capacitance forming electrode drive portion applies voltages to the plurality of capacitance forming electrodes such that a voltage of the same level is provided to each group of n capacitance forming electrodes which are arranged in series in an extending direction of the video signal electrodes (where n is a natural number of 2 or more), and

after all of the scanning signals being applied to the scanning signal electrodes that correspond to the n capacitance forming electrodes, to which the voltage of the same level is applied, completely change from the first level to the second level, the capacitance forming electrode drive portion changes the voltage being applied to the n capacitance forming electrodes, in an opposite direction to all of the scanning signals changing from the first level to the second level.

According to an eleventh aspect of the present invention, in the tenth aspect of the present invention,

one trunk electrode is provided per n capacitance forming electrodes in a region outside an area where the image is displayed, and

each trunk electrode is connected to the n capacitance forming electrodes arranged in series in the extending direction of the video signal electrodes and is also connected to the capacitance forming electrode drive portion.

According to a twelfth aspect of the present invention, in the first aspect of the present invention,

each of the plurality of capacitance forming electrodes is provided so as to correspond to two scanning signal electrodes out of the plurality of scanning signal electrodes, and is arranged between two pixel formation portions which are arranged in series in the extending direction of the video signal electrodes and correspond to the two scanning signal electrodes, the two scanning signal electrodes being arranged in series in the extending direction of the video signal electrodes, and

after all of the scanning signals being applied to the two scanning signal electrodes corresponding to the capacitance forming electrodes completely change from the first level to the second level, the capacitance forming electrode drive portion changes the voltages being applied to the capacitance forming electrodes, in an opposite direction to all of the scanning signals changing from the first level to the second level.

According to a thirteenth aspect of the present invention, in the first aspect of the present invention,

immediately before the scanning signals being applied to the scanning signal electrodes change from the second level to the first level or while the scanning signals are maintained at the first level, the capacitance forming electrode drive portion changes the voltages being applied to the capacitance forming electrodes that correspond to the scanning signal electrodes, in an opposite direction to the scanning signals changing from the second level to the first level.

According to a fourteenth aspect of the present invention, in the first aspect of the present invention,

within one horizontal scanning period from the change of the scanning signals being applied to the scanning signal electrodes from the first level to the second level, the capacitance forming electrode drive portion changes the voltages being applied to the capacitance forming electrodes that correspond to the scanning signal electrodes, in an opposite direction to the scanning signals changing from the first level to the second level.

A fifteenth aspect of the present invention is directed to a method for driving an active-matrix display device having a plurality of video signal electrodes, a plurality of scanning signal electrodes crossing the video signal electrodes, and a plurality of pixel formation portions arranged in a matrix so as to correspond to their respective intersections of the plurality of video signal electrodes and the plurality of scanning signal electrodes, the method comprising:

a video signal electrode drive step for applying video signals to the plurality of video signal electrodes, the signals representing an image to be displayed;

a scanning signal electrode drive step for selectively driving the plurality of scanning signal electrodes by applying scanning signals to the plurality of scanning signal electrodes; and

a capacitance forming electrode drive step for driving a plurality of capacitance forming electrodes provided so as to cross the plurality of video signal electrodes, wherein,

each of the plurality of capacitance forming electrodes is provided so as to correspond to at least one of the plurality of scanning signal electrodes,

each of the pixel formation portions includes:
a switching element to be brought into ON state when a scanning signal being applied to a corresponding scanning signal electrode is at a first level and OFF state when the scanning signal is at a second level, the corresponding scanning signal electrode being a scanning signal electrode passing through the intersection that corresponds to the switching element;
a pixel electrode disposed so as to have a first capacitance formed between the corresponding scanning signal electrode and the pixel electrode and connected via the switching element to a video signal electrode passing through the corresponding intersection; and
a second capacitance formed by the capacitance forming electrode corresponding to the corresponding scanning signal electrode and the pixel electrode, and

in the capacitance forming electrode drive step, after the scanning signals being applied to the scanning signal electrodes change from the first level to the second level, voltages being applied to the capacitance forming electrodes that correspond to the scanning signal electrodes change in an opposite direction to the scanning signals changing from the first level to the second level.

According to a sixteenth aspect of the present invention, in the fifteenth aspect of the present invention,

the capacitance value of the second capacitance is set to M times as great as the capacitance value of the first capacitance (where M is a positive number), and

in the capacitance forming electrode drive step, the capacitance forming electrodes are driven such that the amplitudes of the voltages being applied to the capacitance forming electrodes are set to 1/M of the amplitudes of the scanning signals.

According to a seventeenth aspect of the present invention, in the fifteenth aspect of the present invention,

in the capacitance forming electrode drive step,
voltages are applied to the plurality of capacitance forming electrodes such that a voltage of the same level is provided to each group of n capacitance forming electrodes which are arranged in series in an extending direction of the video signal electrodes (where n is a natural number of 2 or more), and
after all of the scanning signals being applied to the scanning signal electrodes that correspond to the n capacitance forming electrodes, to which the voltage of the same level is applied, completely change from the first level to the second level, the voltage being applied to the n capacitance forming electrodes changes in an opposite direction to all of the scanning signals changing from the first level to the second level.

According to an eighteenth aspect of the present invention, in the fifteenth aspect of the present invention,

in the capacitance forming electrode drive step, immediately before the scanning signals being applied to the scanning signal electrodes change from the second level to the first level or while the scanning signals are maintained at the first level, the voltages being applied to the capacitance forming electrodes that correspond to the scanning signal electrodes change in an opposite direction to the scanning signals changing from the second level to the first level.

According to a nineteenth aspect of the present invention, in the fifteenth aspect of the present invention,

in the capacitance forming electrode drive step, within one horizontal scanning period from the change of the scanning signals being applied to the scanning signal electrodes from the first level to the second level, the voltages being applied to the capacitance forming electrodes that correspond to the scanning signal electrodes change in an opposite direction to the scanning signals changing from the first level to the second level.

### EFFECTS OF THE INVENTION

According to the first aspect of the present invention, each capacitance forming electrode is provided so as to correspond to one or more scanning signal electrodes. A second capacitance is formed between the capacitance forming electrode and a pixel electrode in each pixel formation portion. In such a configuration, after scanning signals being applied to the scanning signal electrodes change from the first level (the level bringing the switching elements into ON state) to the second level (the level bringing the switching elements into OFF state), the capacitance forming electrode drive portion changes the voltages being applied to the capacitance forming electrodes that correspond to the scanning signal electrodes, in an opposite direction (referred to below as a “first direction”) to the scanning signals changing from the first level to the second level. As a result, immediately after the voltages being applied to the capacitance forming electrodes change in the first direction, the pixel electrodes experience potential variations in an opposite direction to potential variations caused in the pixel electrodes due to the presence of first capacitances (capacitances formed between the scanning signal electrodes and the pixel electrodes) at the time of the scanning signals changing from the first level to the second level. Accordingly, when compared to the conventional art, there are smaller differences between the applied voltage when the positive voltage is applied to the pixel electrode and the applied voltage when the negative voltage is applied to the pixel electrode. Thus, occurrence of flicker due to feedthrough voltage can be inhibited. Moreover, unlike in the conventional art, it is not necessary for each pixel formation portion to include a plurality of switching elements, and therefore occurrence of flicker due to feedthrough voltage can be inhibited with a relatively simplified configuration.

According to the second aspect of the present invention, the capacitance value of the second capacitance is set equal to the capacitance value of the first capacitance formed between the scanning signal electrode and the pixel electrode. Accordingly, immediately after the voltage being applied to the capacitance forming electrode changes to the first level, the pixel electrode experiences potential variation to such an extent as to cancel out potential variation caused in the pixel electrode due to the presence of the first capacitance at the time of the scanning signal changing from the first level to the second level. Accordingly, there is no difference between the applied voltage when the positive voltage is applied to the pixel electrode and the applied voltage when the negative voltage is applied to the pixel electrode. Thus, occurrence of flicker due to feedthrough voltage can be prevented.

According to the third aspect of the present invention, the capacitance value of the second capacitance is set greater than the capacitance value of the first capacitance, and each of the voltages being applied to the capacitance forming electrodes has a narrower amplitude than each of the voltages being applied to the scanning signal lines. Here, the greater the capacitance value of the second capacitance is, the more the potential of the pixel electrode varies immediately after the voltage being applied to the capacitance forming electrode changes in the first direction, and the narrower the amplitude of the voltage being applied to the capacitance forming electrode is, the less the potential of the pixel electrode varies. In the third aspect of the invention, the influence of the capacitance value of the second capacitance on the potential variation of the pixel electrode works in an opposite direction to the influence of the amplitude of the voltage being applied to the capacitance forming electrode on the potential variation of the pixel electrode, and therefore, as in the first aspect of the invention, when compared to the conventional art, there are smaller differences between the applied voltage when the positive voltage is applied to the pixel electrode and the applied voltage when the negative voltage is applied to the pixel electrode. Thus, occurrence of flicker due to feedthrough voltage can be inhibited.

According to the fourth aspect of the present invention, occurrence of flicker due to feedthrough voltage can be inhibited, as in the third aspect of the invention.

According to the fifth aspect of the present invention, the capacitance value of the second capacitance is set to M times as great as the capacitance value of the first capacitance, and the amplitude of the voltage being applied to the capacitance forming electrode is set to 1/M of the amplitude of the voltage being applied to the scanning signal line. Here, the greater the capacitance value of the second capacitance is, the more the potential of the pixel electrode varies immediately after the voltage being applied to the capacitance forming electrode changes in the first direction, and the narrower the amplitude of the voltage applied to the capacitance forming electrode is, the less the potential of the pixel electrode varies. In the fifth aspect of the invention, the influence of the capacitance value of the second capacitance on the potential variation of the pixel electrode and the influence of the amplitude of the voltage being applied to the capacitance forming electrode on the potential variation of the pixel electrode cancel each other out, and therefore, as in the second aspect of the invention, there is no difference between the applied voltage when the positive voltage is applied to the pixel electrode and the applied voltage when the negative voltage is applied to the pixel electrode. Thus, occurrence of flicker due to feedthrough voltage can be prevented.

According to the sixth aspect of the present invention, in a display device employing a pixel division method (to improve the dependence on viewing angles in the VA mode, for example), flicker due to feedthrough voltage can be inhibited with a relatively simple configuration.

According to the seventh aspect of the present invention, in a display device employing a pixel division method in which different video signals are provided to the first and second sub-pixel formation portions, so that voltages being applied to the pixel electrodes are different between the first and second sub-pixel formation portions, occurrence of flicker due to feedthrough voltage can be inhibited with a relatively simple configuration.

According to the eighth aspect of the present invention, in a display device employing a pixel division method in which the switching element in the first sub-pixel formation portion and the switching element in the second sub-pixel formation portion are brought into ON state during different periods, so that voltages being applied to the pixel electrodes are different between the first and second sub-pixel formation portions, occurrence of flicker due to feedthrough voltage can be inhibited with a relatively simple configuration.

According to the ninth aspect of the present invention, in a display device employing a pixel division method in which the first and second sub-pixel formation portions have different capacitance values for the third capacitances formed between the pixel electrode and an electrode other than the scanning signal electrode, so that voltages being applied to the pixel electrodes are different between the first and second sub-pixel formation portions, occurrence of flicker due to feedthrough voltage can be inhibited with a relatively simple configuration.

According to the tenth aspect of the present invention, a preferable number of capacitance forming electrodes to which a voltage of the same level is to be applied is determined, making it possible to inhibit occurrence of flicker due to feedthrough voltage.

According to the eleventh aspect of the present invention, n capacitance forming electrodes are connected to one trunk electrode in a region outside a display area. As a result, in the region outside the display area, wiring area for the capacitance forming electrodes is reduced and the number of capacitance forming electrodes to be driven by the capacitance forming electrode drive portion is reduced. Thus, it is possible to achieve a display device with a narrow frame region and at low cost while inhibiting occurrence of flicker due to feedthrough voltage.

According to the twelfth aspect of the present invention, capacitance forming electrodes are commonly used between odd rows and even rows. Thus, it is possible to inhibit a reduction in aperture ratio associated with providing capacitance forming electrodes while preventing occurrence of flicker due to feedthrough voltage.

According to the thirteenth aspect of the present invention, the influence to be exerted by potential variation caused in the pixel electrode due to the presence of the second capacitance when the voltage being applied to the capacitance forming electrode changes in an opposite direction to the first direction is reduced, and therefore occurrence of flicker due to feedthrough voltage can be effectively inhibited.

According to the fourteenth aspect of the present invention, voltages being applied to the capacitance forming electrodes that correspond to the scanning signal electrodes change in the first direction within one horizontal scanning period from the change of the scanning signals being applied to the scanning signal electrodes from the first level to the second level. As a result, after the change of the scanning signals from the first level to the second level causes potential variations of the pixel electrodes, the pixel electrodes experience quick potential variations in an opposite direction to the previous potential variations. Thus, occurrence of flicker due to feedthrough voltage can be effectively inhibited.

### BRIEF DESCRIPTION OF THE DRAWINGS

FIG. 1 is a circuit diagram illustrating the configuration of a pixel formation portion in a liquid crystal display device according to a first embodiment of the present invention.

FIG. 2 is a block diagram illustrating the overall configuration of the liquid crystal display device in the first embodiment.

FIG. 3 is a signal waveform chart describing a drive method in the first embodiment.

FIG. 4 is a circuit diagram illustrating the configuration of a pixel formation portion in a liquid crystal display device according to a second embodiment of the present invention.

FIG. 5 is a circuit diagram illustrating the configuration of a pixel formation portion in a first variant of the second embodiment.

FIG. 6 is a signal waveform chart describing a drive method in the first variant of the second embodiment.

FIG. 7 is a circuit diagram illustrating the configuration of a pixel formation portion in a second variant of the second embodiment.

FIG. 8 is a signal waveform chart describing a drive method in a third embodiment of the present invention.

FIG. 9 is a diagram illustrating a configuration example of a capacitance forming electrode in the third embodiment.

FIG. 10 is a circuit diagram illustrating configurations of pixel formation portions in a variant of the third embodiment.

FIG. 11 is a signal waveform chart describing a drive method in the variant of the third embodiment.

FIG. 12 is a circuit diagram illustrating the configuration of a pixel formation portion where a configuration without auxiliary capacitances is applied to the first embodiment.

FIG. 13 is a circuit diagram illustrating the configuration of a pixel formation portion in a conventional liquid crystal display device.

FIGS. 14A to 14C are signal waveform charts describing feedthrough voltage in the conventional art.

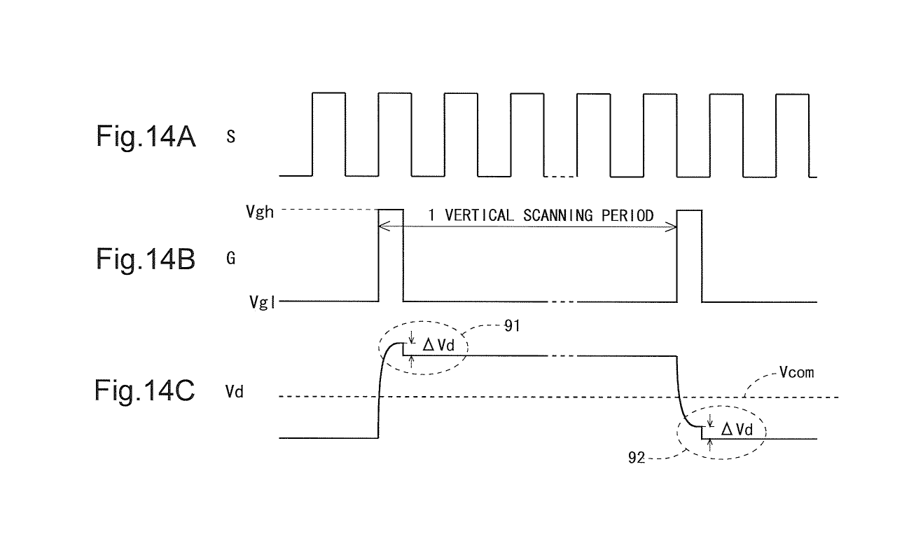

### MODE FOR CARRYING OUT THE INVENTION

Hereinafter, embodiments of the present invention will be described with reference to the accompanying drawings.

<1. First Embodiment>

<1.1 Overall Configuration and Operation>

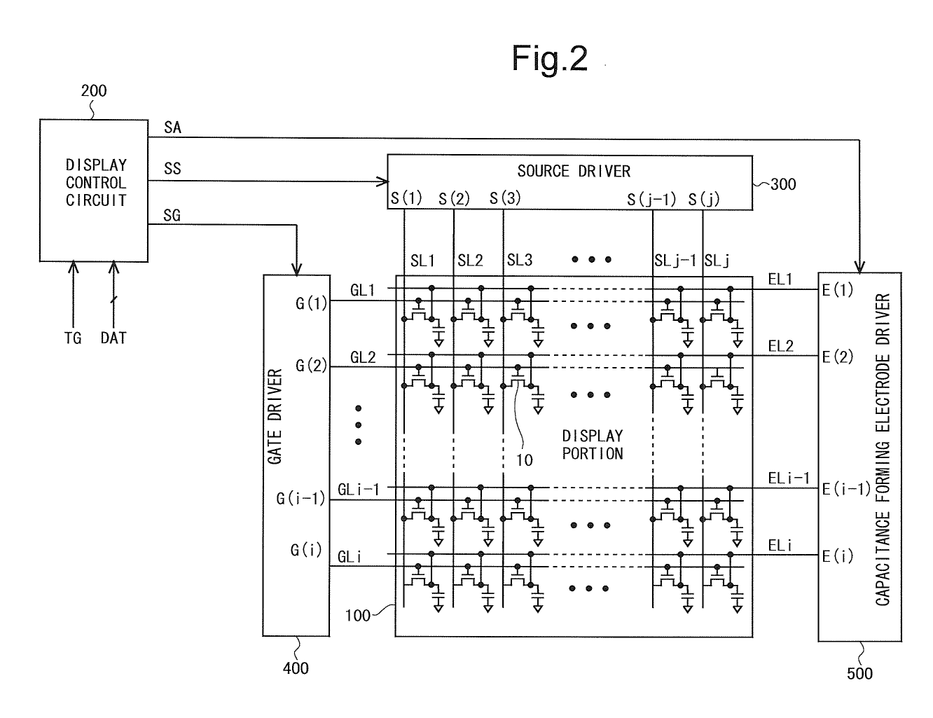

FIG. 2 is a block diagram illustrating the overall configuration of an active-matrix liquid crystal display device according to a first embodiment of the present invention. This liquid crystal display device includes a display portion 100, a display control circuit 200, a source driver (video signal electrode drive portion) 300, a gate driver (scanning signal electrode drive portion) 400, and a capacitance forming electrode driver (capacitance forming electrode drive portion) 500, as shown in FIG. 2. The display portion 100 has formed thereon a plurality (j) of source bus electrodes (video signal electrodes) SL1 to SLj, a plurality (i) of gate bus electrodes (scanning signal electrodes) GL1 to GLi, a plurality (i) of capacitance forming electrodes EL1 to ELi provided in one-to-one correspondence with the gate bus electrodes, and a plurality (i×j) of pixel formation portions provided so as to correspond to their respective intersections of the plurality of source bus electrodes SL1 to SLj and the plurality of gate bus electrodes GL1 to GLi . In this manner, in addition to components of a typical conventional liquid crystal display device, the liquid crystal display device in the present embodiment is provided with the plurality (i) of capacitance forming electrodes EL1 to ELi and the capacitance forming electrode driver 500 for driving them.

The display control circuit 200 receives a data signal DAT and a timing control signal group TG, both of which are transmitted externally, and outputs a source control signal group SS for controlling the operation of the source driver 300, a gate control signal group SG for controlling the operation of the gate driver 400, and a capacitance forming electrode control signal group SA for controlling the operation of the capacitance forming electrode driver 500. The source control signal group SS, the gate control signal group SG, and the capacitance forming electrode control signal group SA include, for example, start pulse signals for starting the operation of the drivers and clock signals for operating sift registers included in the drivers. The source driver 300 receives the source control signal group SS outputted by the display control circuit 200, and applies drive video signals S(1) to S(j) to source bus electrodes SL1 to SLj. The gate driver 400 receives the gate control signal group SG outputted by the display control circuit 200, and applies scanning signals G(1) to G(i) to gate bus electrodes GL1 to GLi, thereby selectively driving gate bus electrodes GL1 to GLi. The capacitance forming electrode driver 500 receives the capacitance forming electrode control signal group SA outputted by the display control circuit 200, and applies capacitance forming electrode drive signals E(1) to E(i) to capacitance forming electrodes EL1 to ELi.

In this manner, drive video signals S(1) to S(j) are applied to source bus electrodes SL1 to SLj, scanning signals G(1) to G(i) are applied to gate bus electrodes GL1 to GLi, and capacitance forming electrode drive signals E(1) to E(i) are applied to capacitance forming electrodes EL1 to ELi, so that an image based on the data signal DAT is displayed on the display portion 100.

<1.2 Configuration of the Pixel Formation Portion>

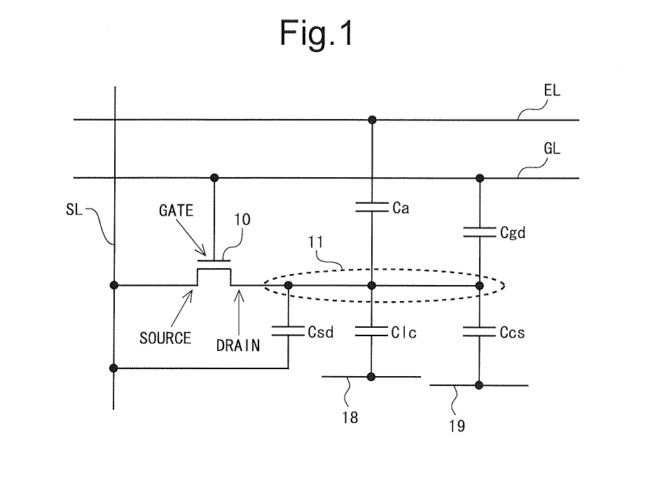

FIG. 1 is a circuit diagram illustrating the configuration of the pixel formation portion in the present embodiment. Note that in FIG. 1, components corresponding to one pixel formation portion are shown. Each pixel formation portion includes a pixel TFT 10, which is connected at a gate electrode to a gate bus electrode GL passing through its corresponding intersection and at a source electrode to a source bus electrode SL passing through the intersection, a pixel electrode 11 connected to a drain electrode of the pixel TFT 10, a common electrode (opposing electrode) 18 and an auxiliary capacitance electrode 19 which are commonly provided for the plurality of pixel formation portions, a pixel capacitance (liquid crystal capacitance) Clc formed by the pixel electrode 11 and the common electrode 18, an auxiliary capacitance Ccs formed by the pixel electrode 11 and the auxiliary capacitance electrode 19, a source-drain capacitance Csd formed by the source bus electrode SL and the drain electrode of the pixel TFT 10 (pixel electrode 11), a gate-drain capacitance Cgd formed by the gate bus electrode GL and the drain electrode of the pixel TFT 10 (the pixel electrode 11), and a capacitance (referred to below as an “additional capacitance”) Ca formed by the capacitance forming electrode EL and the drain electrode of the pixel TFT 10 (the pixel electrode 11) , as shown in FIG. 1. Note that in the following, the capacitance value of the additional capacitance Ca will also be denoted by the same character “Ca”. In this manner, in addition to components as in a typical conventional liquid crystal display device, the pixel formation portion in the present embodiment is provided with the additional capacitance Ca formed by the capacitance forming electrode EL and the drain electrode of the pixel TFT 10 (the pixel electrode 11). Here, the additional capacitance Ca and the gate-drain capacitance Cgd are equal in capacitance value. Note that in the present embodiment, the gate-drain capacitance Cgd realizes a first capacitance, and the additional capacitance realizes a second capacitance.

<1.3 Drive Method>

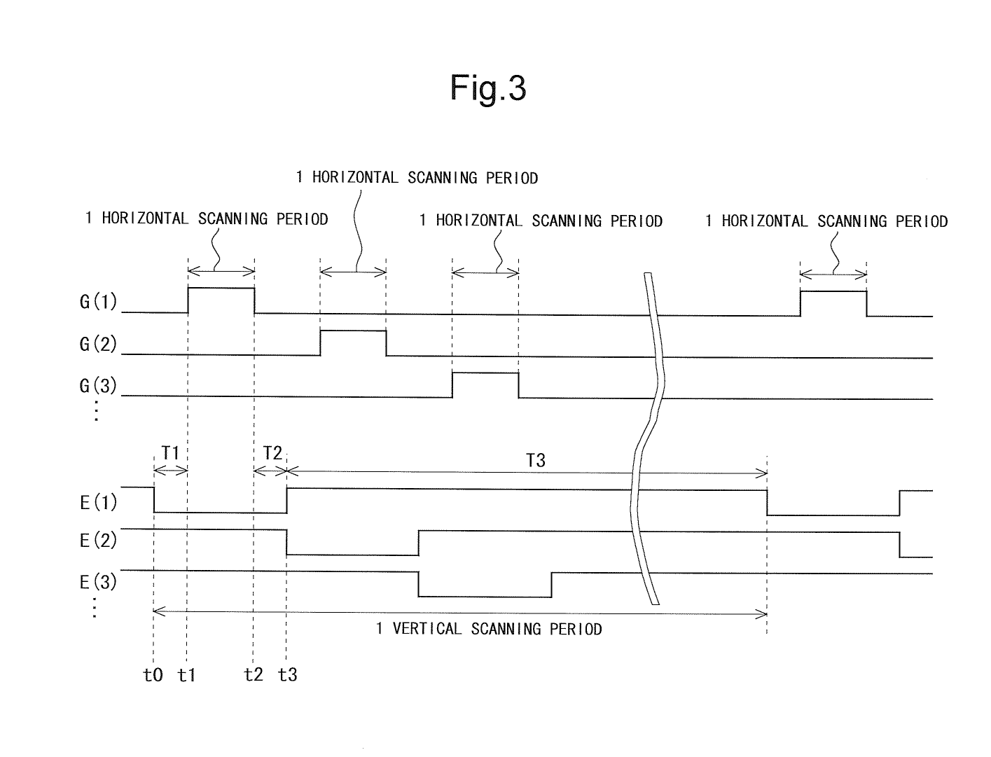

FIG. 3 is a signal waveform chart describing a drive method in the present embodiment. Scanning signals G (k) (where k=1 to i) are sequentially set at high level for a predetermined period (one horizontal scanning period) , one by one from the first-row gate bus electrode GL1 to the i'th-row gate bus electrode GLi, as in the conventional art. Here, the high-level voltage (gate-on voltage) of a scanning signal G (k) is Vgh, and the low-level voltage (gate-off voltage) of the scanning signal G(k) is Vgl.

The capacitance forming electrode drive signal E₍ₖ₎ (where k=1 to i) is set at low level while corresponding scanning signal G (k) is at high level, and set at high level at and after the fall (the change from high level to low level) of their corresponding scanning signal G (k). Moreover, the capacitance forming electrode drive signal E (k) changes from high level to low level immediately before the rise (the change from low level to high level) of their corresponding scanning signal G (k). The high-level voltage of capacitance forming electrode drive signal E (k) is set to gate-on voltage Vgh, and the low-level voltage of capacitance forming electrode drive signal E (k) is set to gate-off voltage Vgl.

<1.4 Action>

While the following description will be given focusing on the first row, the same operation applies to all of the rows. Immediately after time t2 at which scanning signal G (1) falls, the pixel electrode 11 experiences voltage variation (feedthrough voltage) ΔVd1 represented by equation (2) below.

ΔVd1=(Vgh−Vgl)×Cgd/(Clc+Ccs+Csd+Cgd+Ca) (2)

As a result, when a positive voltage (with respect to the potential of the common electrode 18) is applied to the pixel electrode 11, a voltage applied to the liquid crystal is set lower than a desired voltage by ΔVd1, and when a negative voltage is applied to the pixel electrode 11, the voltage applied to the liquid crystal is set higher than a desired voltage by ΔVd1.

After scanning signal G (1) falls, when reaching time t3, capacitance forming electrode drive signal E (1) changes from low level to high level. Immediately after time t3, the pixel electrode 11 experiences voltage variation ΔVd2 represented by equation (3) below.

ΔVd2=(Vgl−Vgh)×Ca/(Clc+Ccs+Csd+Cgd+Ca) (3)

As described above, in the present embodiment, because of “Ca=Cgd”, it can be appreciated from equations (2) and (3) that “ΔVd2=−ΔVd1” is satisfied. Specifically, immediately after time t3 at which capacitance forming electrode drive signal E (1) changes from low level to high level, the potential of the pixel electrode 11 varies so as to cancel out feedthrough voltage ΔVd1 caused immediately after time t2, the time of the fall of scanning signal G (1).

Note that the timing when capacitance forming electrode drive signal E (k) changes from low level to high level after the rise of the scanning signal G (k) should be at the same time when the scanning signal G (k) falls or after the time when the scanning signal G (k) falls. The reason for this is as follows. Assuming that capacitance forming electrode drive signal E (k) changes from low level to high level before the fall of the scanning signal G (k), the pixel electrode 11 does not experience voltage variation ΔVd2 mentioned above because the pixel TFT 10 is not in OFF state. As a result, the effect of feedthrough voltage ΔVd1 caused immediately after time t2, the time of the fall of scanning signal G (1), appears as flicker, for example.

Described next is the timing of changing capacitance forming electrode drive signal E (k) from high level to low level.

When capacitance forming electrode drive signal E (k) changes from high level to low level, the pixel electrode 11 experiences voltage variation ΔVd3 represented by equation (4) below.

ΔVd3=(Vgh−Vgl)×Ca/(Clc+Ccs+Csd+Cgd+Ca) (4)

Because of “Ca=Cgd”, “ΔVd3=ΔVd1” is satisfied from equations (2) and (4).

Here, to reduce the effect due to voltage variation ΔVd3, the timing when capacitance forming electrode drive signal E (k) changes from high level to low level is preferably at the time immediately before the rise of the scanning signal G (k) or during the period in which scanning signal G (k) is at high level. In the example shown in FIG. 3, capacitance forming electrode drive signal E (k) changes from high level to low level at time t0, which is earlier by a slight amount of time T1 than time t1 at which the scanning signal G (k) rises.

<1.5 Effect>

According to the present embodiment, the display portion 100 of the liquid crystal display device has capacitance forming electrodes EL1 to ELi provided in one-to-one correspondence with gate bus electrodes GL1 to GLi. The aforementioned additional capacitances Ca are formed between capacitance forming electrodes EL1 to ELi and the pixel electrodes 11 (the drain electrodes of the pixel TFTs 10) in the pixel formation portion. In such a configuration, capacitance forming electrode drive signals E(1) to E(i) rise after scanning signals G(1) to G(i) for driving gate bus electrodes GL1 to GLi fall. Here, the capacitance value of the additional capacitance Ca is set equal to the capacitance value of the gate-drain capacitance Cgd. Therefore, immediately after the rise of capacitance forming electrode drive signals E(1) to E(i), the pixel electrodes 11 experience potential variations to cancel out potential variations caused in the pixel electrodes 11 due to the fall of scanning signals G(1) to G(i). Accordingly, there is no difference in the voltage applied to the liquid crystal between the case where a positive voltage is applied to the pixel electrodes 11 and the case where a negative voltage is applied to the pixel electrodes 11. As a result, occurrence of flicker due to feedthrough voltage is prevented. Moreover, unlike in the inventions disclosed in Japanese Laid-Open Patent Publication Nos. 4-5633 and 4-14091, it is not necessary to provide an N-channel TFT and a P-channel TFT in each pixel formation portion. Thus, it is possible to prevent occurrence of flicker due to feedthrough voltage with a relatively simple configuration.

Incidentally, as for FIG. 3, the potential of the pixel electrode 11 is affected by voltage variation ΔVd3 during the period denoted by character T1. The potential of the pixel electrode 11 is affected by voltage variation ΔVd1 during the period denoted by character T2. The period denoted by character T3 is a period in which no influence is exerted by voltage variation ΔVd1 and voltage variation ΔVd3. Thus, by setting the duration of T1 and T2 considerably shorter than the duration of T3 (e.g., by setting the duration of each of T1 and T2 within one horizontal scanning period), occurrence of flicker due to feedthrough voltage is effectively prevented.

<1.6 Variant>

In the first embodiment, for the right-and-left direction in FIG. 2, gate bus electrodes GL1 to GLi are arranged so as to extend from the gate driver 400, which is disposed to the left of the display portion 100, to the display portion 100, and capacitance forming electrodes EL1 to ELi are arranged so as to extend from the capacitance forming electrode driver 500, which is disposed to the right of the display portion 100, to the display portion 100. However, the present invention is not limited to this. Both gate bus electrodes GL1 to GLi and capacitance forming electrodes EL1 to ELi may be arranged so as to extend from a driver disposed on one side of the display portion 100 to the display portion 100. Moreover, both gate bus electrodes GL1 to GLi and capacitance forming electrodes EL1 to ELi may be arranged so as to extend from drivers disposed on opposite sides of the display portion 100 to the display portion 100.

<2. Second Embodiment>

<2.1 Configuration of the Pixel Formation Portion>

A second embodiment of the present invention will be described. In the present embodiment, VA mode (vertical alignment mode) is employed as an operation mode of the liquid crystal. Moreover, to improve the dependence on viewing angles in the VA mode, a method in which one pixel is divided into two sub-pixels (referred to below as a “pixel division method”) is employed. Note that the overall configuration and operation of the liquid crystal display device is approximately the same as in the first embodiment, and therefore any descriptions thereof will be omitted. However, since one pixel is divided into two sub-pixels, the number of source bus electrodes is doubled compared to the first embodiment.

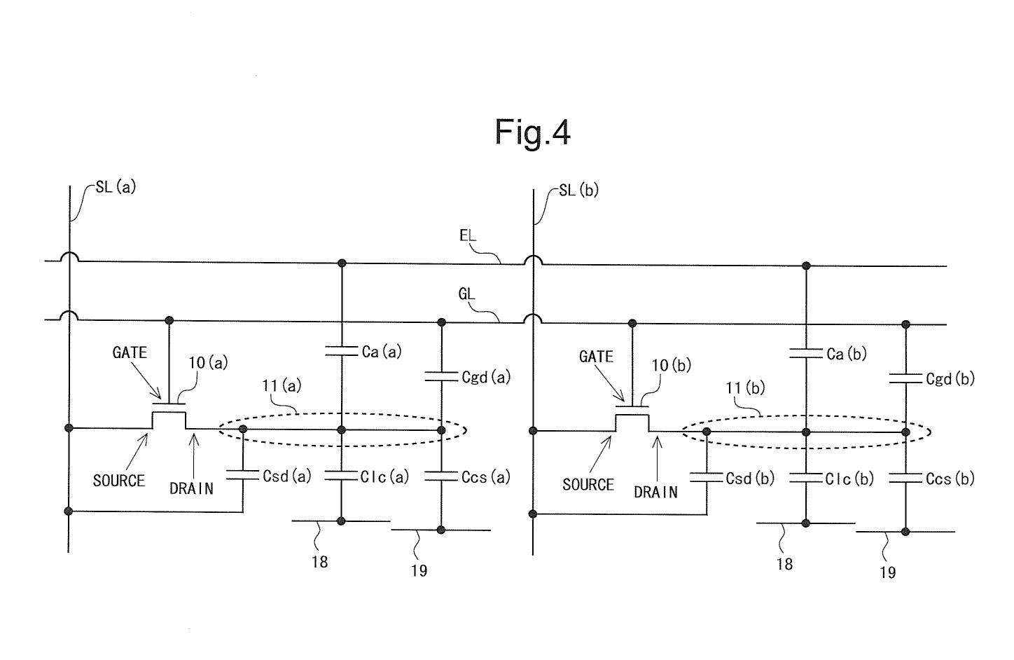

FIG. 4 is a circuit diagram illustrating the configuration of the pixel formation portion in the second embodiment of the present invention. In the present embodiment, one pixel formation portion is composed of a sub-pixel formation portion disposed on the left side in FIG. 4 (referred to below as a “first sub-pixel formation portion”) and a sub-pixel formation portion disposed on the right side in FIG. 4 (referred to below as a “second sub-pixel formation portion”). Note that components of the first sub-pixel formation portion have (a) assigned to their characters, and components of the second sub-pixel formation portion have (b) assigned to their characters. Moreover, as in the first embodiment, capacitances and their capacitance values are denoted by the same characters. Each sub-pixel formation portion has the same configuration as the pixel formation portion in the first embodiment. Accordingly, in the first sub-pixel formation portion, additional capacitance Ca (a) and gate-drain capacitance Cgd (a) are equal in capacitance value, and in the second sub-pixel formation portion, additional capacitance Ca (b) and gate-drain capacitance Cgd (b) are equal in capacitance value.

As shown in FIG. 4, a source electrode of pixel TFT 10(a) in the first sub-pixel formation portion and a source electrode of pixel TFT 10(b) in the second sub-pixel formation portion are connected to different source bus electrodes, SL (a) and SL (b), respectively. Accordingly, by the source driver 300 applying different video signals to source bus electrodes SL (a) and SL (b) , the different voltages can be applied to pixel electrode 11(a) in the first sub-pixel formation portion and pixel electrode 11(b) in the second sub-pixel formation portion. A gate electrode of pixel TFT 10(a) in the first sub-pixel formation portion and a gate electrode of pixel TFT 10(b) in the second sub-pixel formation portion are connected to the same gate bus electrode GL. Other end of the additional capacitance Ca (a) which is connected at one end to pixel electrode 11(a) in the first sub-pixel formation portion and other end of the additional capacitance Ca (b) which is connected at one end to pixel electrode 11(b) in the second sub-pixel formation portion are connected at the same capacitance forming electrode EL. Note that in the present embodiment, source bus electrode SL (b) connected to source electrode of pixel TFT 10(b) in the second sub-pixel formation portion realizes a second video signal electrode.

<2.2 Drive Method>

In the present embodiment, gate bus electrodes GL1 to GLi and capacitance forming electrodes EL1 to ELi are driven in the same manner as in the first embodiment. Specifically, the waveforms of the scanning signals and the waveforms of the capacitance forming electrode drive signals are as shown in FIG. 3, as in the first embodiment.

<2.3 Action>

In the present embodiment, immediately after the fall of the scanning signal, pixel electrode 11(a) in the first sub-pixel formation portion experiences voltage variation ΔVd1a represented by equation (5) below, and pixel electrode 11(b) in the second sub-pixel formation portion experiences voltage variation ΔVd1b represented by equation (6) below.

ΔVd1a=(Vgh−Vgl)×Cgd(a)/(Clc(a)+Ccs(a)+Csd(a)+Cgd(a)+Ca(a)) (5)

ΔVd1b=(Vgh−Vgl)×Cgd(b)/(Clc(b)+Ccs(b)+Csd(b)+Cgd(b)+Ca(b)) (6)

Furthermore, immediately after the capacitance forming electrode drive signal changes from low level to high level, pixel electrode 11(a) in the first sub-pixel formation portion experiences voltage variation ΔVd2a represented by equation (7) below, and pixel electrode 11(b) in the second sub-pixel formation portion experiences voltage variation ΔVd2b represented by equation (8) below.

ΔVd2a=(Vgl−Vgh)×Ca(a)/(Clc(a)+Ccs(a)+Csd(a)+Cgd(a)+Ca(a)) (7)

ΔVd2b=(Vgl−Vgh)×Ca(b)/(Clc(b)+Ccs(b)+Csd(b)+Cgd(b) +Ca(b)) (8)

Here, in the present embodiment, because of “Ca(a)=Cgd(a)” and “Ca(b)=Cgd(b)”, it can be appreciated from equations (5) to (8) that “ΔVd2a=−ΔVd1a” and “ΔVd2b =−ΔVd1b” are satisfied. Specifically, immediately after the capacitance forming electrode drive signal changes from low level to high level, the potential of the pixel electrode 11(a) in the first sub-pixel formation portion and the potential of the pixel electrode 11(b) in the second sub-pixel formation portion vary such that feedthrough voltages ΔVd1a and ΔVd1b caused immediately after the fall of the scanning signal are canceled out.

Note that immediately after the capacitance forming electrode drive signal changes from high level to low level, pixel electrode 11(a) experiences voltage variation ΔVd3a represented by equation (9) below, and the pixel electrode 11(b) experiences voltage variation ΔVd3b represented by equation (10) below.

ΔVd3a=(Vhh−Vgl)×Ca(a)/(Clc(a)+Ccs(a)+Csd(a)+Cgd(a)+Ca(a)) (9)

ΔVd3b=(Vhh−Vgl)×Ca(b)/(Clc(b)+Ccs(b)+Csd(b)+Cgd(b)+Ca(b)) (10)

In the present embodiment, as in the first embodiment, to reduce the effect due to voltage variations ΔVd3a and ΔVd3b, the timing when the capacitance forming electrode drive signal changes from high level to low level is preferably at the time immediately before the rise of the scanning signal or during the period in which the scanning signal is at high level.

<2.4 Effect>

According to the present embodiment, in a liquid crystal display device employing a pixel division method to improve the dependence on viewing angles in the VA mode, both a first sub-pixel formation portion, which is a part of a divided pixel, and a second sub-pixel formation portion, which is the other part of the divided pixel, operate in the following manner . Immediately after the fall of a scanning signal, the potential of a pixel electrode varies as in the conventional art. Thereafter, the capacitance forming electrode drive signal rises, so that the potential of the pixel electrode varies in such a manner as to cancel out a potential variation caused in the pixel electrode immediately after the fall of the scanning signal. Accordingly, in both of the first and second sub-pixel formation portions, there is no difference in the voltage applied to the liquid crystal between the case where a positive voltage is applied to the pixel electrode and the case where a negative voltage is applied to the pixel electrode. Thus, in the liquid crystal display device employing the pixel division method, occurrence of flicker due to feedthrough voltage can be prevented.

<2.5 Variants>

<2.5.1 First Variant>

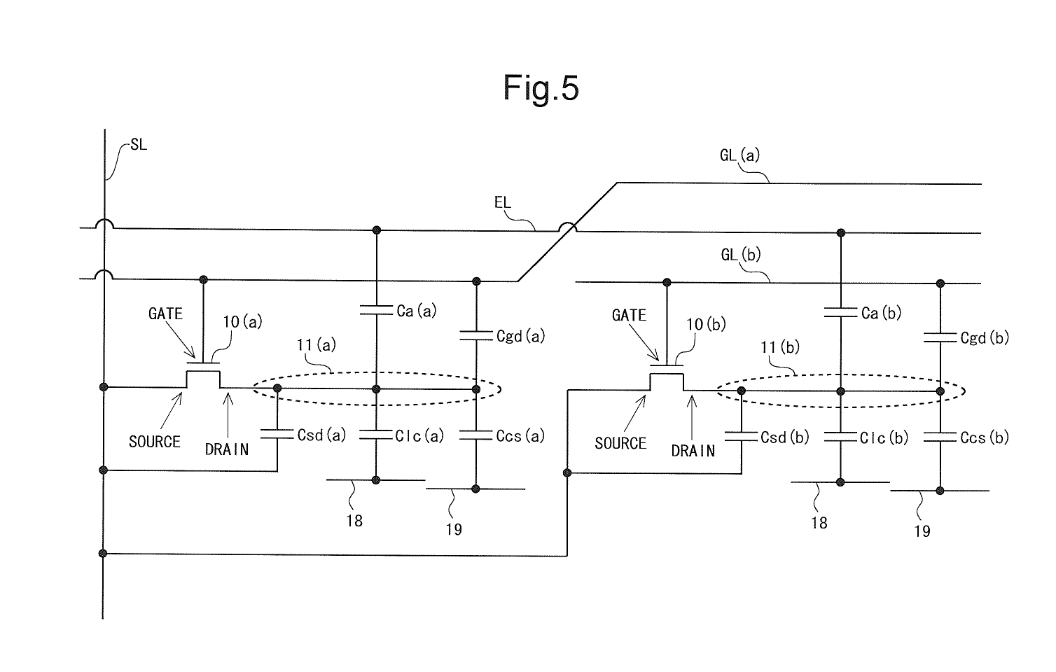

FIG. 5 is a circuit diagram illustrating the configuration of a pixel formation portion in a first variant of the second embodiment. In the present variant, unlike in the second embodiment, the source electrode of pixel TFT 10 (a) in the first sub-pixel formation portion and the source electrode of pixel TFT 10(b) in the second sub-pixel formation portion are connected to the same source bus electrode SL. Moreover, unlike in the second embodiment, the gate electrode of pixel TFT 10(a) in the first sub-pixel formation portion and the gate electrode of pixel TFT 10(b) in the second sub-pixel formation portion are connected to different gate bus electrodes, GL(a) and GL(b), respectively. As a result, in the present variant, although the number of source bus electrodes is the same as in the first embodiment, the number of gate bus electrodes is doubled compared to the first embodiment. Here, the gate driver 400 drives gate bus electrodes GL(a) and GL(b) such that pixel TFT 10(a) in the first sub-pixel formation portion and pixel TFT 10(b) in the second sub-pixel formation portion are set into ON state during their respective different periods, making it possible to apply different voltages to pixel electrode 11(a) in the first sub-pixel formation portion and pixel electrode 11(b) in the second sub-pixel formation portion. In the present variant, additional capacitance Ca(a) and gate-drain capacitance Cgd(a) are equal in capacitance value in the first sub-pixel formation portion, and additional capacitance Ca(b) and gate-drain capacitance Cgd(b) are equal in capacitance value in the second sub-pixel formation portion. Note that in the present variant, gate bus electrode GL_{(b)} connected to the gate electrode of pixel TFT 10 (b) in the second sub-pixel formation portion realizes a second scanning signal electrode.

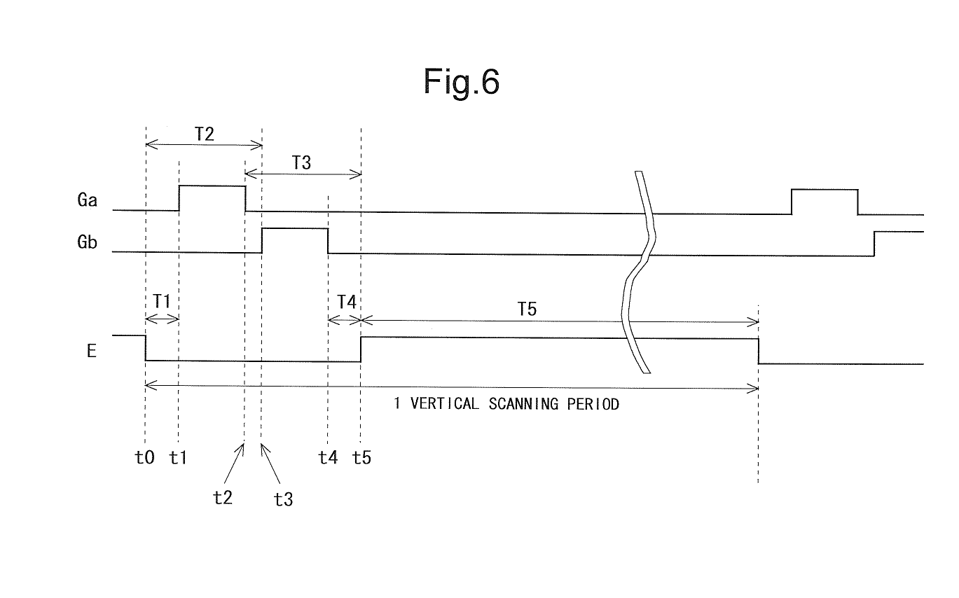

FIG. 6 is a signal waveform chart describing a drive method in the present variant. FIG. 6 shows waveforms for one given row, including scanning signal Ga for controlling the state of pixel TFT 10(a) in the first sub-pixel formation portion, scanning signal Gb for controlling the state of pixel TFT 10 (b) in the second sub-pixel formation portion, and the capacitance forming electrode drive signal E. As shown in FIG. 6, scanning signal Ga is set at high level during the period from time t1 to time t2, and thereafter, scanning signal Gb is set at high level during the period from time t3 to time t4. Here, the capacitance forming electrode drive signal E is driven such that it changes from high level to low level at time t₀ immediately preceding time t1 at which scanning signal Ga rises, and it changes from low level to high level at time t5 after time t4 at which scanning signal Gb falls.

In the present variant, immediately after time t2 at which scanning signal Ga falls, pixel electrode 11(a) in the first sub-pixel formation portion experiences voltage variation ΔVd1a represented by the above-described equation (5), and immediately after time t4 at which scanning signal Gb falls, pixel electrode 11(b) in the second sub-pixel formation portion experiences voltage variation ΔVd1b represented by the above-described equation (6). Moreover, immediately after time t5 at which the capacitance forming electrode drive signal E changes from low level to high level, pixel electrode 11(a) in the first sub-pixel formation portion experiences voltage variation ΔVd2a represented by the above-described equation (7), and pixel electrode 11(b) in the second sub-pixel formation portion experiences voltage variation ΔVd2b represented by the above-described equation (8). Also in the present variant, because of “Ca (a)=Cgd(a)” and “Ca (b)=Cgd (b)”, the potential of pixel electrode 11(a) in the first sub-pixel formation portion and the potential of pixel electrode 11(b) in the second sub-pixel formation portion vary such that voltage variations ΔVd1a and ΔVd1b are canceled out immediately after time t5 at which the capacitance forming electrode drive signal E changes from low level to high level.

In the present variant, the potential of pixel electrode 11(a) in the first sub-pixel formation portion is affected by voltage variation ΔVd3a represented by the above-described equation (9) during the period denoted by character T1 in FIG. 6, and the potential of pixel electrode 11 (b) in the second sub-pixel formation portion is affected by voltage variation ΔVd3b represented by the above-described equation (10) during the period denoted by character T2 in FIG. 6. Moreover, the potential of pixel electrode 11 (a) in the first sub-pixel formation portion is affected by voltage variation ΔVd1a during the period denoted by character T3 in FIG. 6, and the potential of pixel electrode 11 (b) in the second sub-pixel formation portion is affected by voltage variation ΔVd1b during the period denoted by character T4 in FIG. 6. The period denoted by character T5 in FIG. 6 is a period in which no influence is exerted by voltage variations ΔVd1a, ΔVd1b, ΔVd3a, and ΔVd3b. Thus, by setting the duration of each of T1 to T4 significantly shorter than the duration of T5, occurrence of flicker due to feedthrough voltage can be prevented.

<2.5.2 Second Variant>

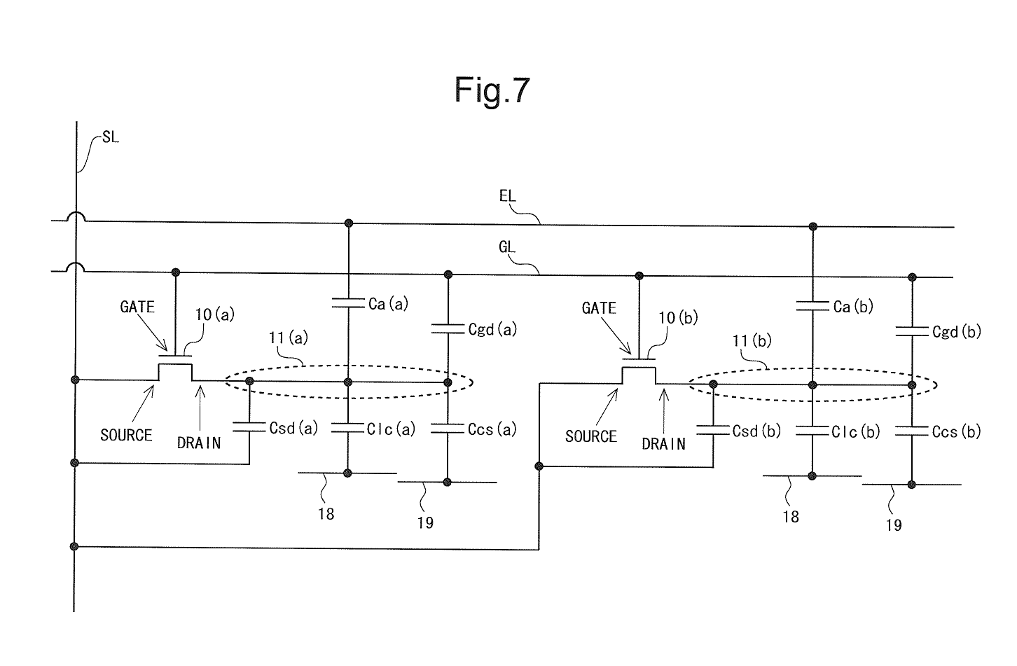

FIG. 7 is a circuit diagram illustrating the configuration of a pixel formation portion in a second variant of the second embodiment. In the present variant, unlike in the second embodiment, the source electrode of pixel TFT 10(a) in the first sub-pixel formation portion and the source electrode of pixel TFT 10(b) in the second sub-pixel formation portion are connected to the same source bus electrode SL. The gate electrode of pixel TFT 10(a) in the first sub-pixel formation portion and the gate electrode of pixel TFT 10(b) in the second sub-pixel formation portion are connected to the same gate bus electrode GL. Thus, in the present variant, the number of source bus electrodes and the number of gate bus electrodes are the same as in the first embodiment. Note that also in the present variant, additional capacitance Ca(a) and gate-drain capacitance Cgd(a) are equal in capacitance value in the first sub-pixel formation portion, and additional capacitance Ca(b) and gate-drain capacitance Cgd(b) are equal in capacitance value in the second sub-pixel formation portion.

In the above configuration, capacitance values of source-drain capacitance Cgd (a) , auxiliary capacitance Ccs (a), and pixel capacitance Clc(a) in the first sub-pixel formation portion are respectively different from those of source-drain capacitance Cgd(b), auxiliary capacitance Ccs(b), and pixel capacitance Clc(b) in the second sub-pixel formation portion. Alternatively, the capacitance value of at least one of the source-drain capacitance, the auxiliary capacitance, and the pixel capacitance differs between the first and second sub-pixel formation portions. As a result, different induced voltages are given in the first and second sub-pixel formation portions, and therefore different voltages can be applied to pixel electrodes 11(a) and 11(b). Note that in the present variant, at least one of the source-drain capacitance, the auxiliary capacitance, and the pixel capacitance realizes a third capacitance.

For example, in the configuration shown in FIG. 1, when the voltage amplitude of a video signal provided to the source bus electrode SL is Vs, induced voltage ΔV1 caused in the pixel electrode 11 due to a voltage change in the video signal is represented by equation (11) below.

ΔV1=Vs×Csd/(Clc+Ccs+Csd+Cgd+Ca) (11)

Moreover, in the case where a drive method is employed in which the polarity of a voltage is inverted every predetermined period with respect to a predetermined potential as for the common electrode drive signal for driving the common electrode 18, when the voltage amplitude of the common electrode drive signal is Vc, induced voltage ΔV2 caused in the pixel electrode 11 due to a voltage change of the common electrode drive signal is represented by equation (12) below. Note that the auxiliary capacitance electrode 19 is driven in the same manner as the common electrode 18.

ΔV2=Vc×(Clc+Ccs)/(Clc+Ccs+Csd+Cgd+Ca) (12)

In the present variant, since the capacitance value of at least one of the source-drain capacitance, the auxiliary capacitance, and the pixel capacitance differs between the first and second sub-pixel formation portions, induced voltages ΔV1 and ΔV2 differ between the first and second sub-pixel formation portions. As a result, different voltages are applied to pixel electrodes 11(a) and 11(b).

While different voltages are applied to pixel electrode 11(a) in the first sub-pixel formation portion and pixel electrode 11(b) in the second sub-pixel formation portion, as described above, potential variations of pixel electrodes 11(a) and 11(b) due to voltage changes of the scanning signal and the capacitance forming electrode drive signal are the same as in the second embodiment. Thus, also in the present variant, occurrence of flicker due to feedthrough voltage can be inhibited.

<3. Third Embodiment>

<3.1 Drive Method and Configuration of the Capacitance Forming Electrode>

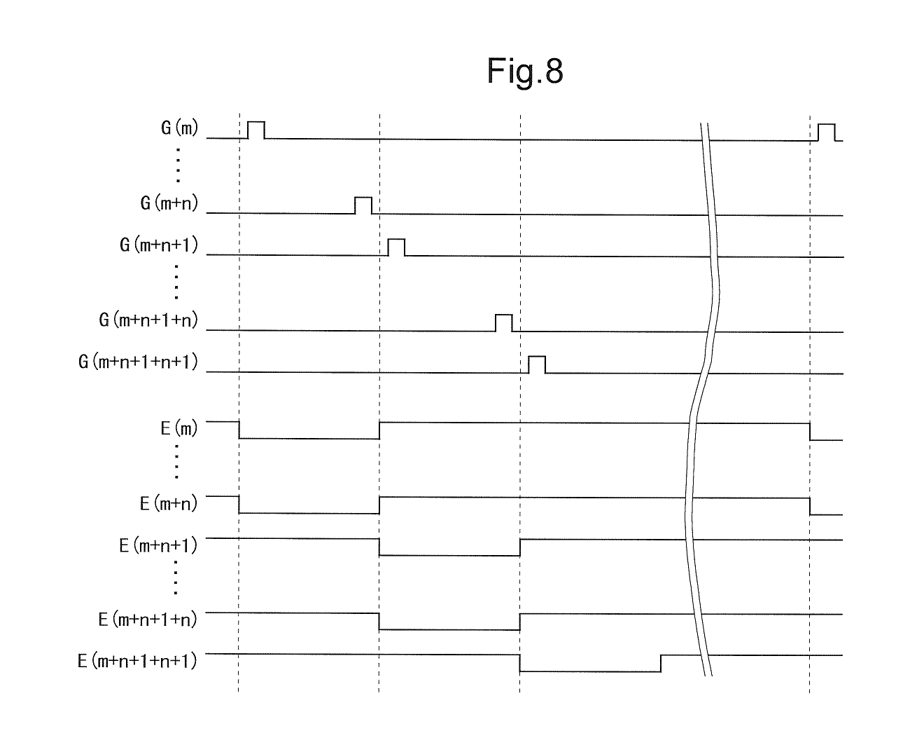

FIG. 8 is a signal waveform chart describing a drive method in the present embodiment. As can be appreciated from FIG. 8, the gate bus electrodes are driven such that an active scanning signal is sequentially provided one-to-one to them, as in the first embodiment (and also in the conventional art). On the other hand, as for the capacitance forming electrodes, a capacitance forming electrode drive signal of the same waveform is provided to n capacitance forming electrodes at a time, unlike in the first embodiment. Here, after the fall of all scanning signals being applied to the gate bus electrodes that correspond to the n capacitance forming electrodes to which the capacitance forming electrode drive signal of the same waveform is provided, the capacitance forming electrode driver 500 causes the capacitance forming electrode drive signals provided to the n capacitance forming electrodes to change from low level to high level.

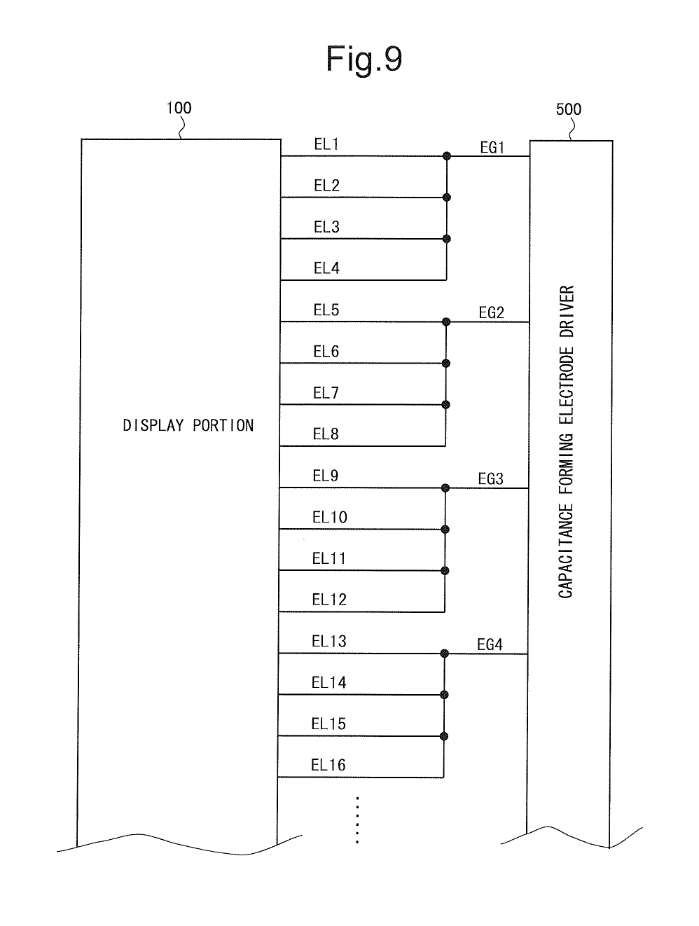

FIG. 9 is a diagram illustrating a configuration example of the capacitance forming electrode in the present embodiment. In the example shown in FIG. 9, each electrode (referred to below as a “capacitance formation trunk electrode ”) extending from the capacitance forming electrode driver 500 is connected to four capacitance forming electrodes in an area between the display portion 100 and the capacitance forming electrode driver 500. In other words, capacitance forming electrodes EL1 to ELi arranged in the display portion 100 are divided into groups of four in an area between the display portion 100 and the capacitance forming electrode driver 500. For example, capacitance forming electrodes EL1 to EL4 corresponding to the gate bus electrodes in the first to forth rows are grouped and connected to capacitance formation trunk electrode EG1. Moreover, for example, capacitance forming electrodes EL13 to EL16 corresponding to the gate bus electrodes in the 13th to 16th rows are grouped and connected to capacitance formation trunk electrode EG4. In such a configuration, when the capacitance forming electrode driver 500 drives capacitance formation trunk electrode EG1, for example, a capacitance forming electrode drive signal of the same waveform is provided to capacitance forming electrodes EL1 to EL4, and when the capacitance forming electrode driver 500 drives capacitance formation trunk electrode EG4, for example , a capacitance forming electrode drive signal of the same waveform is provided to capacitance forming electrodes EL13 to EL16.

<3.2 Effect>

In the present embodiment, by determining the number of capacitance forming electrodes to be grouped such that a period in which influence is exerted by potential variation ΔVd1 at the pixel electrode due to the fall of the scanning signal and a period in which influence is exerted by potential variation ΔVd3 at the pixel electrode due to the rise of the capacitance forming electrode drive signal are significantly shortened, it is possible to prevent occurrence of flicker due to feedthrough voltage with a relatively simplified configuration, as in the first embodiment. Moreover, by grouping the capacitance forming electrodes, a wiring area for the capacitance forming electrodes outside the display portion 100 is reduced, and the number of capacitance forming electrodes to be driven by the capacitance forming electrode driver 500 is reduced. As a result, it is possible to achieve a liquid crystal display device with a narrow frame region and at low cost.

<3.3 Variant>

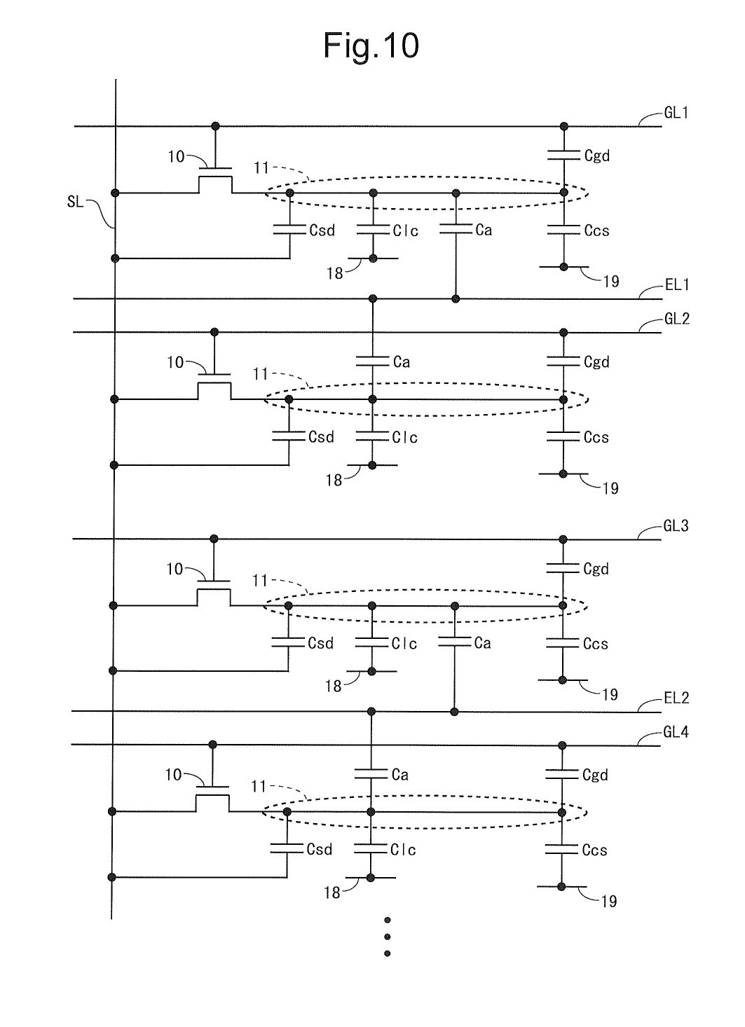

FIG. 10 is a circuit diagram illustrating configurations of pixel formation portions in a variant of the third embodiment. Note that FIG. 10 shows components corresponding to four pixel formation portions arranged in series in the extending direction of the source bus electrode SL. In the present variant, one capacitance forming electrode is provided per two gate bus electrodes arranged in series in the extending direction of the source bus electrode SL, as shown in FIG. 10. Moreover, each capacitance forming electrode is disposed in an area between two pixel formation portions arranged in series in the extending direction of the source bus electrode SL. In FIG. 10, for example, capacitance forming electrode EL1 is disposed in an area between the pixel formation portion corresponding to gate bus electrode GL1 and the pixel formation portion corresponding to gate bus electrode GL2. Moreover, an additional capacitance Ca is formed between the pixel electrode 11 in the pixel formation portion corresponding to gate bus electrode GL1 and capacitance forming electrode EL1, and another additional capacitance Ca is formed between the pixel electrode 11 in the pixel formation portion corresponding to gate bus electrode GL₂ and capacitance forming electrode EL1.

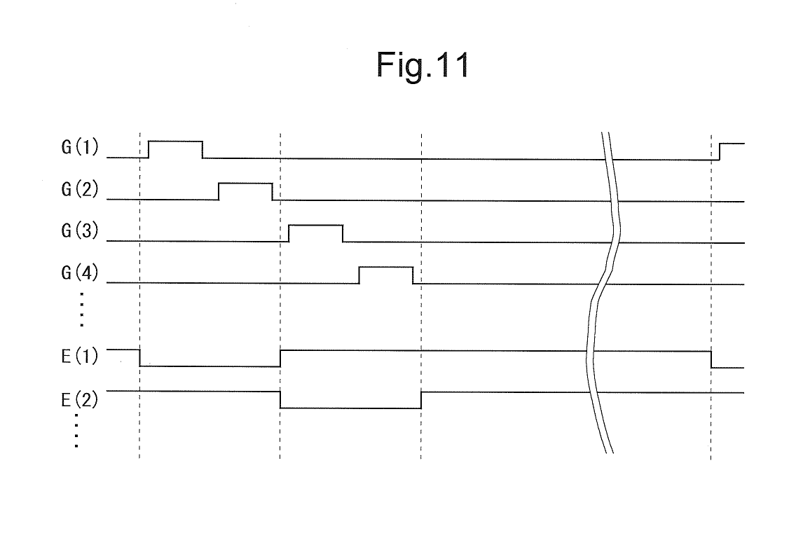

FIG. 11 is a signal waveform chart describing a drive method in the present variant. In the present variant, after both of two scanning signals being applied to two scanning signal electrodes corresponding to a capacitance forming electrode falls, the capacitance forming electrode driver 500 changes a capacitance forming electrode drive signal provided to the capacitance forming electrode from low level to high level, as shown in FIG. 11. Moreover, immediately before one of the scanning signals being applied to the two scanning signal electrodes corresponding to the capacitance forming electrode rises, the capacitance forming electrode driver 500 changes the capacitance forming electrode drive signal provided to the capacitance forming electrode from high level to low level. Here, in the present variant, capacitance forming electrodes are commonly used between odd rows and even rows, as described above. Thus, it is possible to inhibit a reduction in aperture ratio associated with providing capacitance forming electrodes, and also prevent occurrence of flicker due to feedthrough voltage.

<4. Other Variants>

<4.1 Regarding Types of Pixel TFTs>

In the embodiments, N-channel TFTs are used as pixel TFTs. However, the present invention is not limited to this. The present invention can be applied to the case where P-channel TFTs are employed as pixel TFTs.

<4.2 Regarding the Relationship between the Capacitance Value of the Additional Capacitance and the Capacitance Value of the Gate-Drain Capacitance>

In the embodiments, the additional capacitance Ca and the gate-drain capacitance Cgd are equal in capacitance value. However, the present invention is not limited to this. The capacitance value of the additional capacitance Ca can be set to M times (where M is a positive number) as great as the gate-drain capacitance Cgd.

The following description will be given taking as an example the case where a configuration with the additional capacitance Ca having a capacitance value two times greater than the gate-drain capacitance Cgd is applied to the first embodiment. In this case, the capacitance value of the additional capacitance Ca is twice the capacitance value of the gate-drain capacitance Cgd, and therefore “Ca=2C d” is satisfied. Moreover, the capacitance forming electrode driver 500 sets the amplitude of the capacitance forming electrode drive signal E (k) to “(Vgh−Vgl)/2”.

Referring now to FIG. 3, the potential variation of the pixel electrode 11 in the present variant will be described. Immediately after time t2 at which scanning signal G(1) falls, the pixel electrode 11 experiences voltage variation (feedthrough voltage) ΔVd1 represented by the above-described equation (2) as in the first embodiment. At time t3 after the fall of scanning signal G(1), capacitance forming electrode drive signal E(1) changes from low level to high level. Immediately after time t3, the pixel electrode 11 experiences voltage variation ΔVd2M represented by equation (13).

ΔVd2M=((Vgl−Vgh)/2)×Ca/(Clc+Ccs+Csd+Cgd+Ca) (13)

In the present variant, because of “Ca=2Cgd”, as mentioned above, it can be appreciated from the above-described equation (2) and the above-described equation (13) that “ΔVd2M=−ΔVd1” is satisfied. Specifically, immediately after time t3 at which capacitance forming electrode drive signal E(1) changes from low level to high level, the potential of the pixel electrode 11 varies such that feedthrough voltage ΔVd1 caused immediately after time t2 at which scanning signal G (1) falls is canceled out. Note that the description herein has been given focusing on the first row, but similar operations are performed in all rows.

As described above, also by setting the capacitance value of the additional capacitance Ca M times (where M is a positive number) greater than that of the gate-drain capacitance Cgd and by setting the amplitude of the capacitance forming electrode drive signal E (k) to (1/M) of that of the scanning signal G(k), occurrence of flicker due to feedthrough voltage can be prevented as well.

Note that in the case where the capacitance value of the additional capacitance Ca is set to M times (where M is a positive number) as great as the capacitance value of the gate-drain capacitance Cgd, by setting the amplitude of the capacitance forming electrode drive signal E(k) to approximately (1/M) of the amplitude of the scanning signal G (k), it is possible to inhibit, though not completely prevent, occurrence of flicker due to feedthrough voltage.

<4.3 Regarding Configuration without Auxiliary Capacitances>

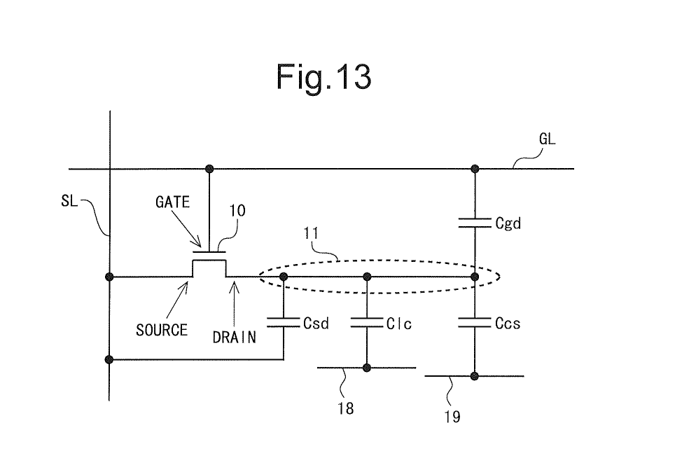

To reliably hold voltages to be applied to liquid crystals, most liquid crystal display devices are equipped with auxiliary capacitances Ccs in parallel with pixel capacitances (liquid crystal capacitances) Clc, as shown in FIG. 13. However, there are liquid crystal display devices without auxiliary capacitances Ccs. Therefore, the following description will be given taking as an example a case where configuration without auxiliary capacitances Ccs is applied to the first embodiment.

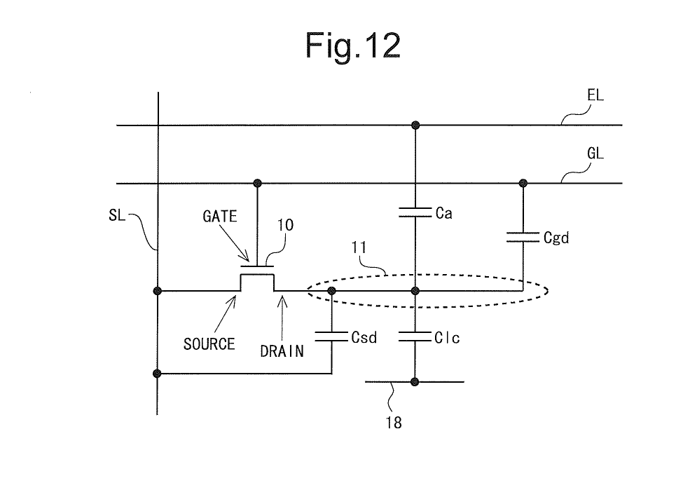

FIG. 12 is a circuit diagram illustrating the configuration of a pixel formation portion in the present variant. Unlike in the configuration of the first embodiment shown in FIG. 1, the pixel formation portion is not provided with the auxiliary capacitance electrode 19 and the auxiliary capacitance Ccs. Referring now to FIG. 3, the potential variation of the pixel electrode 11 in the present variant will be described. Note that, although the description will be given focusing on the first row, similar operations are performed in all rows.

Immediately after time t2 at which scanning signal G(1) falls, the pixel electrode 11 experiences voltage variation (feedthrough voltage) ΔVd1c represented by equation (14) below.

ΔVd1c=((Vgh−Vgl)×Cgd/(Clc+Csd+Cgd+Ca) (14)

At time t3 after the fall of scanning signal G(1), capacitance forming electrode drive signal E(1) changes from low level to high level. Immediately after time t3, the pixel electrode 11 experiences voltage variation ΔVd2c represented by equation (15) below.

ΔVd2c=((Vgl−Vgh)×Ca/(Clc+Csd+Cgd+Ca) (15)

Here, when the additional capacitance Ca and the gate-drain capacitance Cgd are equal in capacitance value as in the first embodiment, i.e., “Ca=Cgd” is satisfied, “ΔVd2c=−ΔVd1c” is satisfied from the above-described equation (14) and the above-described equation (15). Accordingly, immediately after time t3 at which capacitance forming electrode drive signal E(1) changes from low level to high level, the potential of the pixel electrode 11 varies such that feedthrough voltage ΔVd1 caused immediately after time t2 at which scanning signal G(1) falls is canceled out.

As described above, even in the case of a liquid crystal display device without auxiliary capacitances Ccs, by applying the present invention, occurrence of flicker due to feedthrough voltage can be prevented as well.

### DESCRIPTION OF THE REFERENCE CHARACTERS

10, 10(a), 10(b) pixel TFT

11, 11(a), 11(b) pixel electrode

100 display portion

200 display control circuit

300 source driver

400 gate driver

500 capacitance forming electrode driver

GL, GL1 to GLi gate bus electrode

SL, SL1 to SLj source bus electrode

EL, EL1 to ELi capacitance forming electrode

G(1) to G(i) scanning signal

S(1) to S(j) video signal

E(1) to E(i) capacitance forming electrode drive signal

Clc, Clc(a), Clc(b) pixel capacitance (liquid crystal capacitance)

Ccs, Ccs(a), Ccs(b) auxiliary capacitance

Csd, Csd(a), Csd(b) source-drain capacitance

Cgd, Cgd(a), Cgd(b) gate-drain capacitance

Ca, Ca(a), Ca(b) additional capacitance

1. An active-matrix display device having a plurality of video signal electrodes, a plurality of scanning signal electrodes crossing the plurality of video signal electrodes, and a plurality of pixel formation portions arranged in a matrix so as to correspond to their respective intersections of the plurality of video signal electrodes and the plurality of scanning signal electrodes, the device comprising:
a plurality of capacitance forming electrodes crossing the plurality of video signal electrodes;
a video signal electrode drive portion for applying video signals to the plurality of video signal electrodes, the signals representing an image to be displayed;
a scanning signal electrode drive portion for selectively driving the plurality of scanning signal electrodes by applying scanning signals to the plurality of scanning signal electrodes; and
a capacitance forming electrode drive portion for driving the plurality of capacitance forming electrodes, wherein,
each of the plurality of capacitance forming electrodes is provided so as to correspond to at least one of the plurality of scanning signal electrodes,
each of the pixel formation portions includes:
a switching element to be brought into ON state when a scanning signal being applied to a corresponding scanning signal electrode is at a first level and OFF state when the scanning signal is at a second level, the corresponding scanning signal electrode being a scanning signal electrode passing through the intersection that corresponds to the switching element;
a pixel electrode disposed so as to have a first capacitance formed between the corresponding scanning signal electrode and the pixel electrode and connected via the switching element to a video signal electrode passing through the corresponding intersection; and
a second capacitance formed by the capacitance forming electrode corresponding to the corresponding scanning signal electrode and the pixel electrode, and
after the scanning signals being applied to the scanning signal electrodes change from the first level to the second level, the capacitance forming electrode drive portion changes voltages being applied to the capacitance forming electrodes that correspond to the scanning signal electrodes, in an opposite direction to the scanning signals changing from the first level to the second level.

2. The display device according to claim 1, wherein,
the capacitance value of the second capacitance is set equal to the capacitance value of the first capacitance, and
after scanning signals being applied to the scanning signal electrodes change from the first level to the second level, the capacitance forming electrode drive portion changes the voltages being applied to the capacitance forming electrodes that correspond to the scanning signal electrodes, from the second level to the first level.

3. The display device according to claim 1, wherein,
the capacitance value of the second capacitance is set greater than the capacitance value of the first capacitance, and
the capacitance forming electrode drive portion drives the capacitance forming electrodes such that the amplitudes of the voltages being applied to the capacitance forming electrodes are narrower than those of the scanning signals.

4. The display device according to claim 1, wherein,
the capacitance value of the second capacitance is set smaller than the capacitance value of the first capacitance, and
the capacitance forming electrode drive portion drives the capacitance forming electrodes such that the amplitudes of the voltages being applied to the capacitance forming electrodes are wider than those of the scanning signals.

5. The display device according to claim 1, wherein,
the capacitance value of the second capacitance is set to M times as great as the capacitance value of the first capacitance (where M is a positive number), and
the capacitance forming electrode drive portion drives the capacitance forming electrodes such that the amplitudes of the voltages being applied to the capacitance forming electrodes are set to 1/M of the amplitudes of the scanning signals.

6. The display device according to claim 1, wherein each of the pixel formation portions consists of a first sub-pixel formation portion and a second sub-pixel formation portion, each including the switching element, the pixel electrode, and the second capacitance.

7. The display device according to claim 6, further comprising a plurality of second video signal electrodes the number of which is equal to the number of the plurality of video signal electrodes, wherein,
the video signal electrode drive portion further applies the video signals to the plurality of second video signal electrodes,
the pixel electrode included in the first sub-pixel formation portion is connected to the video signal electrode via the switching element, and
the pixel electrode included in the second sub-pixel formation portion is connected to the second video signal electrode via the switching element.

8. The display device according to claim 6, further comprising a plurality of second video signal electrodes the number of which is equal to the number of plurality of scanning signal electrodes, wherein,
the scanning signal electrode drive portion further applies the scanning signals to the plurality of second scanning signal electrodes, thereby selectively driving the plurality of scanning signal electrodes and the plurality of second scanning signal electrodes such that the scanning signal electrodes and the second scanning signal electrodes are alternately selected, and
in the second sub-pixel formation portion,
the switching element is brought into ON state when a scanning signal not being applied to the corresponding scanning signal electrode but instead to a corresponding second scanning signal electrode is at a first level and OFF state when the scanning signal is at a second level, the corresponding second scanning signal electrode being a second scanning signal electrode passing through the intersection that corresponds to the switching element,
the pixel electrode is disposed so as to have the first capacitance formed between the corresponding second scanning signal electrode, in place of the corresponding scanning signal electrode, and the pixel electrode, and
after both the scanning signals being applied to the scanning signal electrodes that correspond to the capacitance forming electrodes and the scanning signals being applied to the second scanning signal electrodes that correspond to the capacitance forming electrodes completely change from the first level to the second level, the capacitance forming electrode drive portion changes the voltages being applied to the capacitance forming electrodes, in an opposite direction to both of the scanning signals changing from the first level to the second level.

9. The display device according to claim 6, wherein,
the pixel electrode included in each of the pixel formation portions is disposed so as to have a third capacitance formed between an electrode other than the corresponding scanning signal electrode and the pixel electrode, and
the third capacitance is different in capacitance value between the first sub-pixel formation portion and the second sub-pixel formation portion.

10. The display device according to claim 1, wherein,
the capacitance forming electrode drive portion applies voltages to the plurality of capacitance forming electrodes such that a voltage of the same level is provided to each group of n capacitance forming electrodes which are arranged in series in an extending direction of the video signal electrodes (where n is a natural number of 2 or more), and
after all of the scanning signals being applied to the scanning signal electrodes that correspond to the n capacitance forming electrodes, to which the voltage of the same level is applied, completely change from the first level to the second level, the capacitance forming electrode drive portion changes the voltage being applied to the n capacitance forming electrodes, in an opposite direction to all of the scanning signals changing from the first level to the second level.

11. The display device according to claim 10, wherein,
one trunk electrode is provided per n capacitance forming electrodes in a region outside an area where the image is displayed, and
each trunk electrode is connected to the n capacitance forming electrodes arranged in series in the extending direction of the video signal electrodes and is also connected to the capacitance forming electrode drive portion.

12. The display device according to claim 1, wherein,
each of the plurality of capacitance forming electrodes is provided so as to correspond to two scanning signal electrodes out of the plurality of scanning signal electrodes, and is arranged between two pixel formation portions which are arranged in series in the extending direction of the video signal electrodes and correspond to the two scanning signal electrodes, the two scanning signal electrodes being arranged in series in the extending direction of the video signal electrodes, and
after all of the scanning signals being applied to the two scanning signal electrodes corresponding to the capacitance forming electrodes completely change from the first level to the second level, the capacitance forming electrode drive portion changes the voltages being applied to the capacitance forming electrodes, in an opposite direction to all of the scanning signals changing from the first level to the second level.

13. The display device according to claim 1, wherein immediately before the scanning signals being applied to the scanning signal electrodes change from the second level to the first level or while the scanning signals are maintained at the first level, the capacitance forming electrode drive portion changes the voltages being applied to the capacitance forming electrodes that correspond to the scanning signal electrodes, in an opposite direction to the scanning signals changing from the second level to the first level.

14. The display device according to claim 1, wherein within one horizontal scanning period from the change of the scanning signals being applied to the scanning signal electrodes from the first level to the second level, the capacitance forming electrode drive portion changes the voltages being applied to the capacitance forming electrodes that correspond to the scanning signal electrodes, in an opposite direction to the scanning signals changing from the first level to the second level.

15. A method for driving an active-matrix display device having a plurality of video signal electrodes, a plurality of scanning signal electrodes crossing the video signal electrodes, and a plurality of pixel formation portions arranged in a matrix so as to correspond to their respective intersections of the plurality of video signal electrodes and the plurality of scanning signal electrodes, the method comprising:
a video signal electrode drive step for applying video signals to the plurality of video signal electrodes, the signals representing an image to be displayed;
a scanning signal electrode drive step for selectively driving the plurality of scanning signal electrodes by applying scanning signals to the plurality of scanning signal electrodes; and
a capacitance forming electrode drive step for driving a plurality of capacitance forming electrodes provided so as to cross the plurality of video signal electrodes, wherein,
each of the plurality of capacitance forming electrodes is provided so as to correspond to at least one of the plurality of scanning signal electrodes,
each of the pixel formation portions includes:
a switching element to be brought into ON state when a scanning signal being applied to a corresponding scanning signal electrode is at a first level and OFF state when the scanning signal is at a second level, the corresponding scanning signal electrode being a scanning signal electrode passing through the intersection that corresponds to the switching element;
a pixel electrode disposed so as to have a first capacitance formed between the corresponding scanning signal electrode and the pixel electrode and connected via the switching element to a video signal electrode passing through the corresponding intersection; and
a second capacitance formed by the capacitance forming electrode corresponding to the corresponding scanning signal electrode and the pixel electrode, and
in the capacitance forming electrode drive step, after the scanning signals being applied to the scanning signal electrodes change from the first level to the second level, voltages being applied to the capacitance forming electrodes that correspond to the scanning signal electrodes change in an opposite direction to the scanning signals changing from the first level to the second level.

16. The drive method according to claim 15, wherein,
the capacitance value of the second capacitance is set to M times as great as the capacitance value of the first capacitance (where M is a positive number), and
in the capacitance forming electrode drive step, the capacitance forming electrodes are driven such that the amplitudes of the voltages being applied to the capacitance forming electrodes are set to 1/M of the amplitudes of the scanning signals.

17. The drive method according to claim 15, wherein,
in the capacitance forming electrode drive step,
voltages are applied to the plurality of capacitance forming electrodes such that a voltage of the same level is provided to each group of n capacitance forming electrodes which are arranged in series in an extending direction of the video signal electrodes (where n is a natural number of 2 or more), and
after all of the scanning signals being applied to the scanning signal electrodes that correspond to the n capacitance forming electrodes, to which the voltage of the same level is applied, completely change from the first level to the second level, the voltage being applied to the n capacitance forming electrodes changes in an opposite direction to all of the scanning signals changing from the first level to the second level.

18. The drive method according to claim 15, wherein in the capacitance forming electrode drive step, immediately before the scanning signals being applied to the scanning signal electrodes change from the second level to the first level or while the scanning signals are maintained at the first level, the voltages being applied to the capacitance forming electrodes that correspond to the scanning signal electrodes change in an opposite direction to the scanning signals changing from the second level to the first level.

19. The drive method according to claim 15, wherein in the capacitance forming electrode drive step, within one horizontal scanning period from the change of the scanning signals being applied to the scanning signal electrodes from the first level to the second level, the voltages being applied to the capacitance forming electrodes that correspond to the scanning signal electrodes change in an opposite direction to the scanning signals changing from the first level to the second level.
